(19) United States
(12) Patent Application Publication
(10) Pub. No.: US 2007/0255966 A1
(43) Pub. Date: Nov. 1, 2007

(54) Cryptographic circuit with voltage-based tamper detection and response circuitry

(76) Inventors: Vincenzo Condorelli, Poughkeepsie, NY (US); Kevin C. Gotze, Poughkeepsie, NY (US); Nihad Hadzic, Wappingers Falls, NY (US)

Correspondence Address: DILLION & YUDELL LLP, 8911 N. CAPITAL OF TEXAS HWY, SUITE 2110, AUSTIN, TX, 78759, US

(21) Appl. No.: 11/416,005

(22) Filed: May 1, 2006

(51) Int. Cl. G06F 12/14

(52) U.S. Cl. 713/194

(57) ABSTRACT

A cryptographic circuit with voltage island-based tamper detection and response is disclosed. The circuit includes a voltage island having at least one monitoring circuit and a first storage area for security parameters. The circuit also includes a second storage area for key storage and management logic to tamper the security parameters upon detection of an environmental failure.

### BACKGROUND OF THE INVENTION

1. Field of the Invention

The present invention relates in general to cryptography and particularly to securing cryptographic systems against extraction of data. Still more particularly, the present invention relates to a system, method and computer program product for voltage-based tamper detection and response in a cryptographic circuit.

2. Description of Background

In order to insure proper operation in a secure manner, physically secure cryptographic modules must be resilient to attacks which may attempt to exploit the tendency of devices to malfunction as they are pushed out of their operational environmental tolerances with respect to high or low temperature and voltage. A well known example of such an attack is the cooling of DRAM devices below −20 C, which causes data to be persistently maintained even after the device is turned off. An example of such an attack is described in Ross Anderson's book, Security Engineering at page 282.). At the other end of the spectrum, SRAM device designers must be concerned about data being permanently “burnt-in” at high temperatures and voltages.

There are two basic strategies to defend against such an attack. A cryptographic module can either be designed and rigorously tested to insure that no such environmental weakness exists (through a process called environmental failure testing) or it can independently monitor its own temperature and voltage to insure that any sensitive data is destroyed prior to the device exiting its designed operational environment. This latter technique is called environmental failure protection. While both of these techniques are valid under validation programs such as NIST's FIPS-140 (National Institute for Standards and Technology's Federal Information Processing Standard-140), the testing approach has several serious weaknesses. First, testing can be complicated and expensive, and if a problem is uncovered, discovery occurs near the time when a device is scheduled to ship, causing an untimely design re-spin. Second, as designs grow more and more complex and manufacturing processes vary more over time, the likelihood of a possible latent design weakness slipping by testing greatly increases. Thus the security assurance provided via testing is weak at best. Environmental Failure Protection (EFP), if affordable within the design constraints, is therefore generally considered to be the best option available.

For multi-chip cryptographic modules, which typically contain several semiconductors and associated passive components in a secure enclosure, environmental failure protection is fairly easy to achieve. Typically, a protection system can be implemented with a microcontroller and several passive components that consume less than 100 microwatts. Low power consumption is important, because the protection system must be operational during shipping/storage and is often powered from a battery back-up during these times.

The prior art has, however, failed to provide adequate protection for a single chip cryptographic module, because such protection requires the chip to have an uninterrupted source of power, which consumes significant amounts of power, even when most circuits are not switching.

### SUMMARY OF THE INVENTION

The shortcomings of the prior art are overcome and additional advantages are provided through the provision of a cryptographic circuit with voltage island-based tamper detection and response. The circuit includes a voltage island having at least one monitoring circuit and a first storage area for security parameters. The circuit also includes a second storage area for key storage and management logic to tamper the security parameters upon detection of an environmental failure.

Methods and computer program products corresponding to the above-summarized system are also described and claimed herein. Additional features and advantages are realized through the techniques of the present invention. Other embodiments and aspects of the invention are described in detail herein and are considered a part of the claimed invention. For a better understanding of the invention with advantages and features, refer to the description and to the drawings.

As a result of the summarized invention, a solution which, by keeping only the core security logic powered when the device isn't being functionally operated, lowers the power consumption of a cryptographic device in storage by several orders of magnitude, is provided. This reduction in power requirements extends the battery “shelf-life” of a device by several orders of magnitude (and into a practical range for usable products).

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1A illustrates one example of a cryptographic circuit with voltage island-based tamper detection and response in a system operation state under normal power;

FIG. 1B illustrates one example of a cryptographic circuit with voltage island-based tamper detection and response in a shipping state using battery backup; and

FIG. 1C illustrates one example of a cryptographic circuit with voltage island-based tamper detection and response in a tamper response state.

The detailed description explains the preferred embodiments of the invention, together with advantages and features, by way of example with reference to the drawings.

### DETAILED DESCRIPTION OF THE INVENTION

The present invention uses a device with a voltage island, which is a small portion of a chip that is electrically isolated and draws power from its own power supply. Examples of systems using voltage islands include servers storing vital product data and supporting system reset and bring up. The Voltage Island technique, in concert with custom logic described below, is used by the present invention to produce a viable power-efficient on-chip environmental failure protection system.

The present invention consists of a small, low power consumption, voltage island containing one or several monitoring circuits (e.g., Temperature Sensitive Ring Oscillators, Voltage sensitive Ring oscillators, or PLL lock/clock frequency monitors if an on-island clock oscillator isn't implemented), a storage area for critical security parameters (e.g., a “tampered/untampered bit” and key storage for a device private key or “root of trust” key, cryptographic keys, digital signatures, etc.) and management logic to zeroize or tamper the critical security parameters upon detection of environmental failure. Additional functionality, such as a driver/receiver inhibit-on-tamper feature will be included in some embodiments of the present invention.

By keeping only the core security logic powered when the device isn't being functionally operated, the present invention reduces power consumption by several orders of magnitude, and thus increases the battery “shelf-life” by several orders of magnitude (and into a practical range for real world products). Alternatively, a less secure single chip cryptographic module could integrate this design component and add the capability to constantly monitor tamper and environmental conditions. Such a chip would become more secure against attacks that exploit any of the environmental or tamper modes that that implementation monitors.

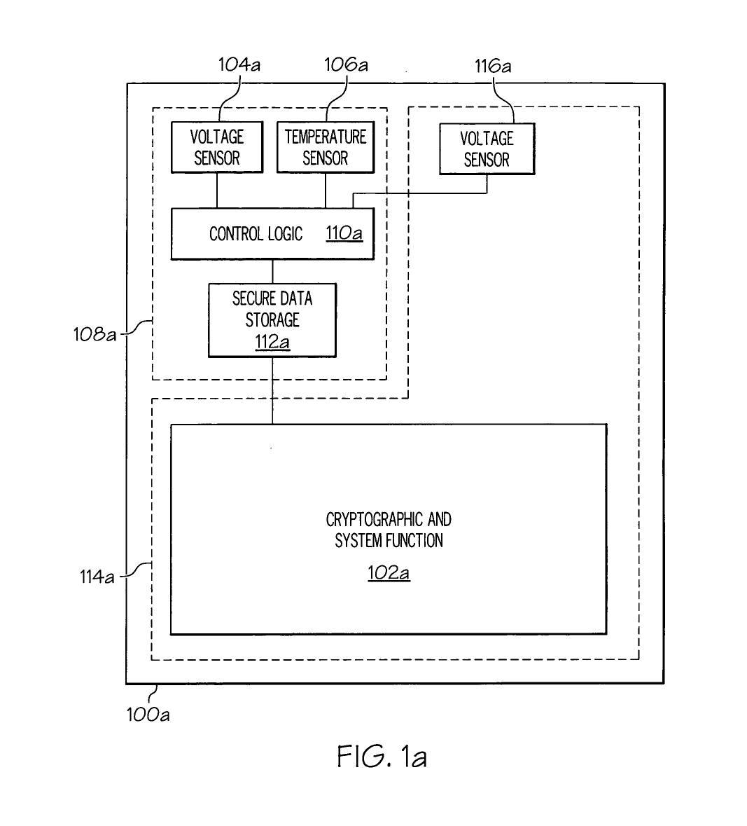

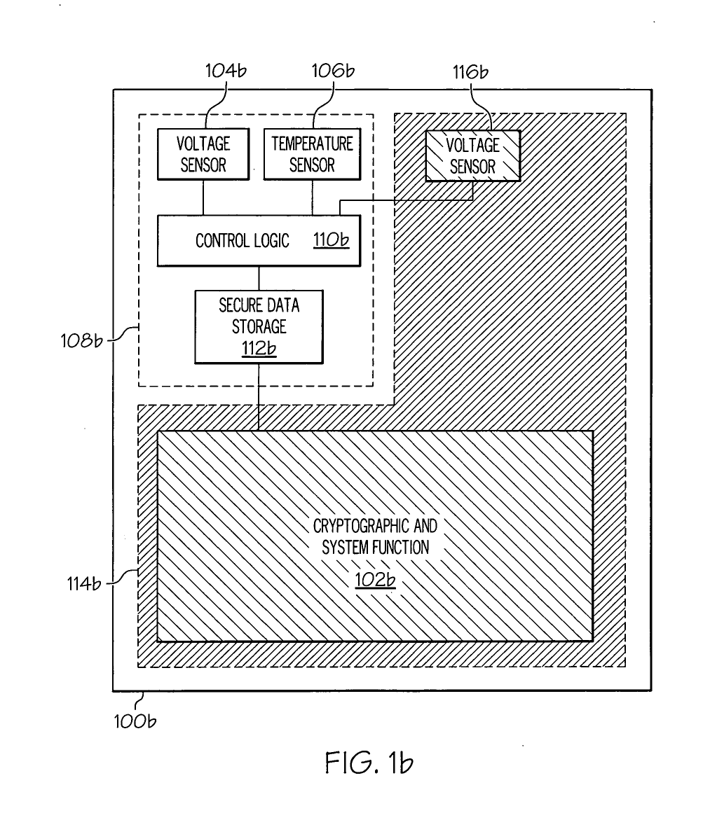

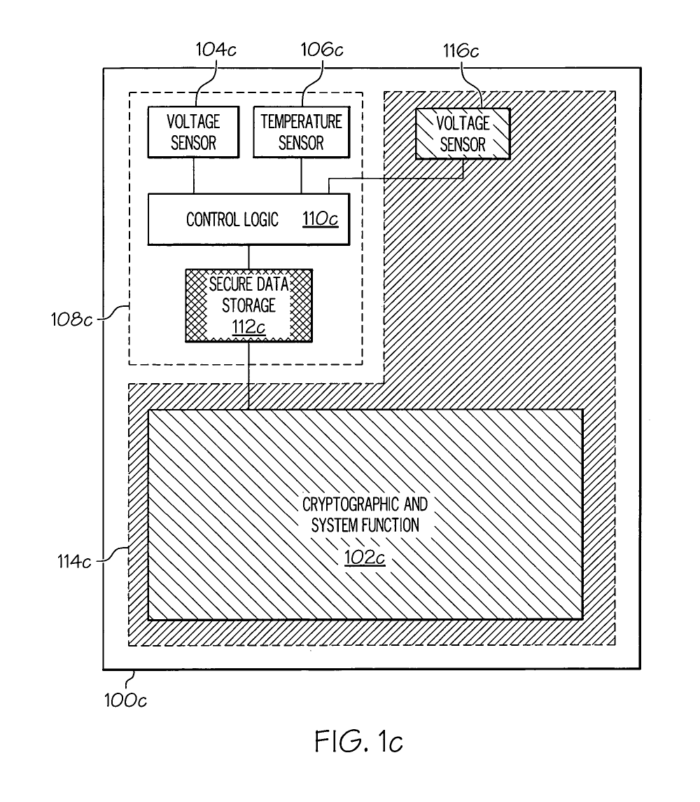

Turning now to the figures, and in particular to FIG. 1A, an example of a cryptographic circuit with voltage island-based tamper detection and response in a system operation state under normal power is depicted. Circuit 100a contains a cryptographic and system function circuit 102a, residing on a first voltage island 114a with a first voltage sensor 116a. During the operation state under normal power depicted in FIG. 1A, cryptographic and system function circuit 102a and first voltage sensor 116a are in an active state and are powered. First voltage island 114a is active.

On a second voltage island 108a, a second voltage sensor 104a and a temperature sensor 106a connect to control logic 110a, the same control logic 110a to which first voltage sensor 116a connects. Control logic 110a is also connected to a secure data storage unit 112a on second voltage island 108a, and secure data storage unit 112a connects to cryptographic and system function circuit 102a. During the operation state under normal power depicted in FIG. 1A, second voltage island 108a is active, and second voltage sensor 104a, temperature sensor 106a, secure data storage unit 112a and control logic 110a are active and powered.

FIG. 1B illustrates one example of a cryptographic circuit with voltage island-based tamper detection and response in a shipping state using battery backup. Circuit 100b contains a cryptographic and system function circuit 102b, residing on a first voltage island 114b with a first voltage sensor 116b. During the shipping state using battery backup depicted in FIG. 1B, cryptographic and system function circuit 102b and first voltage sensor 116b are in a passive (off) state. First voltage island 114b is disabled.

On a second voltage island 108b, a second voltage sensor 104b and a temperature sensor 106b connect to control logic 110b, the same control logic 110b to which first voltage sensor 116b connects. Control logic 110b is also connected to a secure data storage unit 112b on second voltage island 108b, and secure data storage unit 112b connects to cryptographic and system function circuit 102b. During the shipping state using battery backup depicted in FIG. 1B, second voltage island 108b is active, and second voltage sensor 104b, temperature sensor 106b, secure data storage unit 112b and control logic 110b are active and powered.

FIG. 1C illustrates one example of a cryptographic circuit with voltage island-based tamper detection and response in a tamper response state. Circuit 100c contains a cryptographic and system function circuit 102c, residing on a first voltage island 114c with a first voltage sensor 116c. During the tamper response state depicted in FIG. 1C, cryptographic and system function circuit 102c and first voltage sensor 116c are in an indeterminate state due to tampering. First voltage island 114c is in an indeterminate state due to tampering.

On a second voltage island 108c, a second voltage sensor 104c and a temperature sensor 106c connect to control logic 110c, the same control logic 110c to which first voltage sensor 116c connects. Control logic 110c is also connected to a secure data storage unit 112c on second voltage island 108c, and secure data storage unit 112c connects to cryptographic and system function circuit 102c. During the tamper response state depicted in FIG. 1B, second voltage island 108c is active, and second voltage sensor 104c, temperature sensor 106c and control logic 110b are active and powered. Secure data storage unit 112c is zeroized.

In an example implementation for outbound authentication, Circuit 100a will remotely prove its identity and integrity, a step which is vital to the operation of devices such crypto coprocessors. The relevant process of outbound authentication is detailed in Sean Smith's “Outbound Authentication for Programmable Secure Coprocessors”, which is incorporated by reference, and is well-understood by those skilled in the art. A special cryptographic key (called a device private key) is stored secure data storage unit 112a of circuit 100a to prove the identity of circuit 100a over a network and prove that circuit 100a is untampered.

At the time of manufacture of circuit 100a, this device private key is loaded into secure data storage unit 112a on second voltage island 108a. Circuit 100a powered down to battery backup and shipped to a customer in the state depicted as circuit 100b. The customer then activates a system containing circuit 100b and requests that the system to perform a remote authentication with the device private key stored in secure data storage unit 112b. The remote authentication can only succeed if the system restores power to circuit 100b, restoring the conditions of circuit 100a, and discovers that circuit 100a is untampered.

If circuit 100b was tampered, the circuit 100b will have entered the tamper state depicted as circuit 100c and will exhibit the lack of a device private key. The system containing circuit 100c, having experienced a “tamper” event, such as temperature or voltage measurement caused control logic to zeroize the private key stored in secure data storage unit 112c, will no longer be trusted to operate securely.

Assuming that circuit 100b is received untampered, a customer can place circuit 100b into a system and circuit 100b will operate normally after restoring the conditions of circuit 100a. If the device ever experiences a tamper event while operating under the conditions of circuit 100a, circuit 100a enters the tampered state depicted as circuit 100c and the device private key stored in secure data storage unit 112c is deleted. Because the device private key stored in secure data storage unit 112c is only known to circuit 100a through access to secure data storage unit 112c, and circuit 100a is designed not to communicate the private key, circuit 100a can be trusted to delete the private key stored in secure data storage unit 112a whenever circuit 100a is tampered. Any system that can sign a message with a device private key can benefit from the use of circuit 100a. When secure data storage unit 112a contains a private key, users of circuit 100a can rest assured that the circuit has not been tampered.

In a preferred embodiment, first voltage sensor 116a and second voltage sensor 104a are embodied as power-optimized ring oscillators that are slowed as much as possible. There is a trade-off between power (base Ring-oscillator frequency), the time it takes to detect a tamper, and the precision of each specific temperature measurement.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A cryptographic circuit with voltage island-based tamper detection and response, said circuit comprising:
a voltage island having at least a first monitoring circuit;
a first storage area for security parameters;
a second storage area for key storage; and
management logic to tamper said security parameters upon detection of an environmental failure by said first monitoring circuit.

2. The circuit of claim 1, wherein said first storage area and said second storage area are co-located on a secure data storage unit.

3. The circuit of claim 1, further comprising a second voltage island having at least a second monitoring circuit.

4. The circuit of claim 3, wherein said second monitoring circuit is a temperature sensor.

5. The circuit of claim 3, wherein said second monitoring circuit is a voltage sensor.

6. The circuit of claim 1, wherein said first monitoring circuit is a voltage sensor.

7. The circuit of claim 1, wherein said first monitoring circuit is a temperature sensor.

8. A cryptographic circuit with voltage island-based tamper detection and response, said circuit comprising:
a first voltage island hosting a first monitoring sensor and a cryptographic and system function unit; and
a second voltage island hosting a second monitoring sensor, a secure data storage unit holding one or more security parameters, a third monitoring sensor, and control logic to tamper said security parameters in said secure data storage unit upon detection of an environmental failure by one of said first monitoring sensor, said second monitoring sensor and said third monitoring sensor.

9. The circuit of claim 8, wherein said first monitoring sensor, said second monitoring sensor, said third monitoring sensor and said secure data storage unit connect to said control logic.

10. The circuit of claim 8, wherein said cryptographic and system function unit connects to said secure data storage unit.

11. The circuit of claim 8, wherein said first monitoring sensor is a voltage sensor, said second monitoring sensor is a temperature sensor, and said third monitoring sensor is a voltage sensor.

12. The circuit of claim 11, wherein said first monitoring sensor and said third monitoring sensor are power-optimized ring oscillators.

13. A circuit for voltage island-based tamper detection, said circuit comprising:
a voltage island residing on a larger Integrated circuit chip, said chip comprising
at least one monitoring circuit,
a storage area for secret data, and
management logic to zeroize said secret data upon detection of tampering or environmental failure.

14. The circuit of claim 13, wherein said monitoring circuit further comprises logic for communicating said environmental failure or tampering to said management logic.

15. The circuit of claim 14, wherein said management logic further comprises logic to zeroize through erasure caused by active overwriting said secret data stored in said storage area based on one or more items of information received from said monitor circuit

16. The circuit of claim 15, wherein said monitoring circuit is comprised of one or more of the set comprising a temperature monitor, a voltage monitor, a frequency oscillator monitor, a physical penetration monitor, an off-island monitor, and an off-chip monitor.

17. The circuit of claim 16, wherein said secret data in storage area is comprised of one or more of the set of a symmetric cryptographic key, an asymmetric cryptographic key, a digital signature, a hash value, a polynomial, a linear feedback shift register value, a one-time pad value, or a critical security parameter.

18. The circuit of claim 17, wherein said voltage island is constantly powered regardless of whether power is supplied to a remainder of said chip.

19. The circuit of claim 18, wherein said management logic can turn off a main voltage region and send a signal to said main voltage region to flush any secret data that may have been exported off said voltage island.

20. The circuit of claim 19, wherein said data may be entered into said storage area during a manufacturing process, using a cryptographic protocol in said field via an off chip interface to said management logic that can authenticate said command and enter said new data into said secure data storage area.
